(19) United States
(12) Patent Application Publication
(10) Pub. No.: US 2024/0079677 A1
(43) Pub. Date: Mar. 7, 2024

(54) COOLING STRUCTURE OF BATTERY PACK

(71) Applicant: SUBARU CORPORATION, Tokyo (JP)

(72) Inventors: Tatsuya ISHIKAWA, Tokyo (JP); Toshiaki NARUKE, Tokyo (JP)

(21) Appl. No.: 18/233,719

(22) Filed: Aug. 14, 2023

(30) Foreign Application Priority Data
Sep. 6, 2022 (JP) 2022-141633

(51) Int. Cl. H01M 10/6563; H01M 10/613; H01M 10/625

(52) U.S. Cl. CPC H01M 10/6563; H01M 10/613; H01M 10/625

(57) ABSTRACT

A cooling structure of a battery pack includes a battery case, an intake duct, and a blower. The battery case contains a battery module. The intake duct communicates with the battery case and is configured to send cooling air for cooling the battery module. The blower is configured to supply the cooling air to the intake duct. The intake duct has a bent section in which the cooling air that is sent from an upper side to a lower side is sent again from the lower side to the upper side. In the bent section of the intake duct, a vibration absorber is provided at least at a collision area to be collided with the cooling air.

### CROSS-REFERENCE TO RELATED APPLICATIONS

The present application claims priority from Japanese Patent Application No. 2022-141633 filed on Sep. 6, 2022, the entire contents of which are hereby incorporated by reference.

### BACKGROUND

The disclosure relates to a cooling structure of a battery pack.

Existing cooling structures of battery packs include a structure disclosed in Japanese Unexamined Patent Application Publication (JP-A) No. 2019-199110, for example.

A battery pack includes battery modules, a battery case for containing the battery modules, a cooling duct for sending cooling air to the battery case, and a first blower for supplying cooling air to the cooling duct. The battery case and the cooling duct are coupled via the first blower. In addition, a dust filter and a second blower for removing foreign matters such as dust, which are accumulated on the dust filter, are interposed between the first blower and the cooling duct.

Air in a vehicle cabin of a vehicle is sucked into the cooling duct by the first blower and is used as cooling air. Cooling air passes through the dust filter before being sent to the battery case, whereby foreign matters contained in the cooling air are removed by the dust filter. The second blower is electronically controlled by an electronic control unit, and it sends outside air to the dust filter to remove foreign matters accumulated thereon.

### SUMMARY

An aspect of the disclosure provides a cooling structure of a battery pack. The cooling structure includes a battery case, an intake duct, and a blower. The battery case contains a battery module. The intake duct communicates with the battery case and is configured to send cooling air for cooling the battery module. The blower is configured to supply the cooling air to the intake duct. The intake duct has a bent section in which the cooling air that is sent from an upper side to a lower side is sent again from the lower side to the upper side. In the bent section of the intake duct, a vibration absorber is provided at least at a collision area to be collided with the cooling air.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a perspective view of a vehicle mounted with a cooling structure of a battery pack of an embodiment of the disclosure.

FIG. 2 is a schematic view of the cooling structure of the battery pack of the embodiment of the disclosure.

FIG. 3A is a sectional view of the cooling structure of the battery pack of the embodiment of the disclosure.

FIG. 3B is a sectional view of the cooling structure of the battery pack of the embodiment of the disclosure.

FIG. 4 is a schematic view of the cooling structure of the battery pack of another embodiment of the disclosure.

FIG. 5 is a schematic view of the cooling structure of the battery pack of an embodiment of the disclosure.

### DETAILED DESCRIPTION

In the cooling structure of a battery pack disclosed in JP-A No. 2019-199110, a cooling duct is coupled to a part in the vicinity of an upper surface of a battery case, via a first blower. The cooling duct extends upward of a vehicle so as to take in air in a vehicle cabin. Cooling air passes through a dust filter and is then sent to the battery case.

In the existing cooling structure having such a configuration, noises such as operation noise of the first blower, fluid noise generated by cooling air that is flowing in an air duct, and noise generated by cooling air that is passing through the dust filter. In addition, it is difficult to remove vibrations from these noises in an air passage in which cooling air flows from an upper side to a lower side of the battery case. As a result, these noises are transmitted to the inside of the vehicle cabin and can cause discomfort to occupants in the vehicle cabin, such that conversation among occupants is interrupted, or occupants have difficulty in listening to music.

In the existing cooling structure, which uses the dust filter and the second blower, foreign matters in cooling air are easily removed. On the other hand, this cooling structure has a large number of constituent components and has a complicated air passage structure, which makes it difficult to reduce manufacturing cost. Moreover, this cooling structure is large in size as a whole apparatus and occupies a large housing space that is not easy to obtain. In one example, for electric vehicles that are mounted with a lot of battery modules, it is difficult to ensure a space for housing the battery modules.

It is desirable to provide a cooling structure of a battery pack, in which a bent section is provided to an intake duct, and a vibration absorber is disposed at an area to be collided with cooling air, in the bent section, resulting in reduction in amount of generated noise.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

Hereinafter, a cooling structure 10 of a battery pack 11 according to the embodiment of the disclosure will be described in detail based on the drawings. The front-rear direction illustrated on the paper represents a longitudinal width direction of the battery pack 11, the right-left direction illustrated on the paper represents a lateral width direction of the battery pack 11, and the up-down direction illustrated on the paper represents a height direction of the battery pack 11.

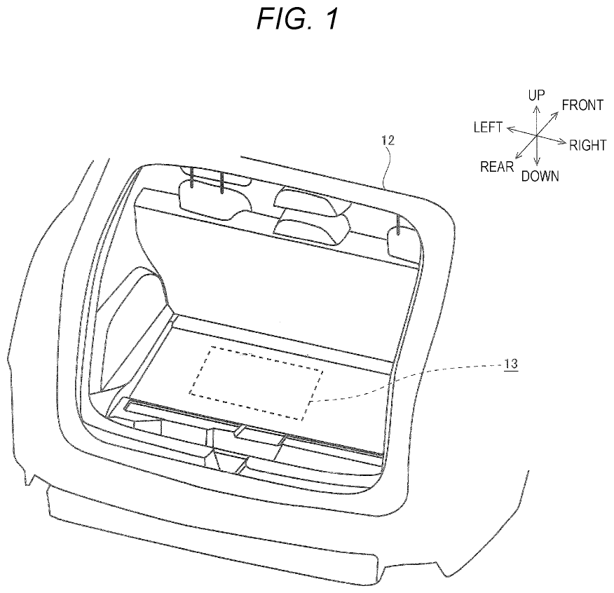

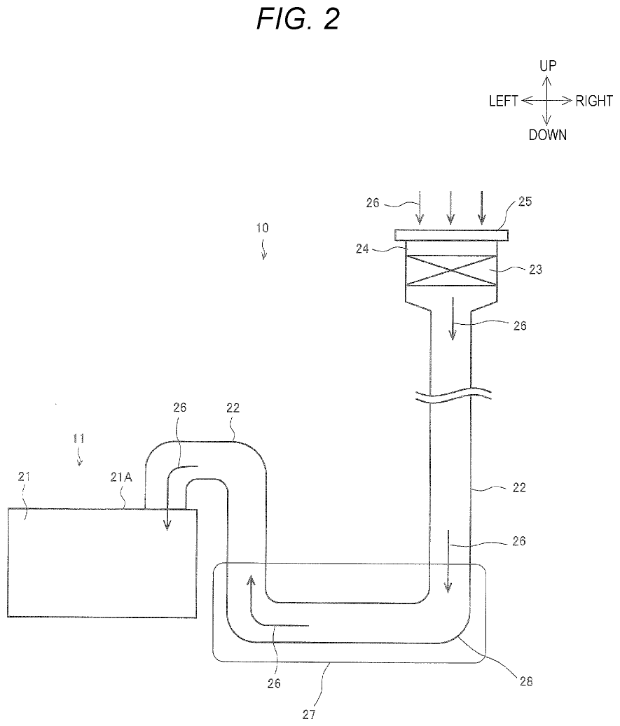

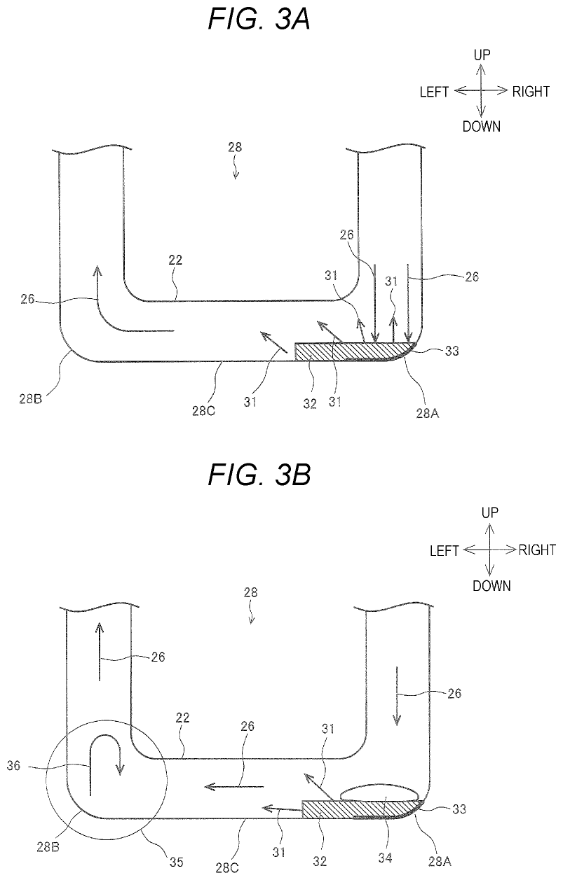

FIG. 1 is a perspective view of a vehicle 12 mounted with the cooling structure 10 of the battery pack 11 of the embodiment. FIG. 2 is a schematic view of the cooling structure 10 of the battery pack 11 of the embodiment. FIGS. 3A and 3B are sectional views of a bent section 28 of an intake duct 22 of the cooling structure 10 of the battery pack 11 of the embodiment.

As illustrated in FIG. 1, the vehicle 12, which is an automobile, a train, or the like, is mounted with the battery pack 11 (refer to FIG. 2) for supplying power to a motor and various electric components. For automobiles that can be used as the vehicle 12, electric vehicles (EVs), hybrid electric vehicles (HEVs), plug-in hybrid electric vehicles (PHEVs), and so on, have been spread in recent years.

The battery pack 11 is placed in, for example, a housing space 13 under a rear floor on a rear side of the vehicle 12. The battery pack 11 is placed so that its longer direction of the battery pack 11 will coincide with the vehicle width direction of the vehicle 12. The placement position of the battery pack 11 is not limited to the housing space 13 under the rear floor and may be a housing space such as under a front floor on which a driver's seat and a passenger seat of the vehicle 12 are placed. The direction of the contained battery pack 11 can be changed in design as desired, depending on the shape of the housing space 13.

As illustrated in FIG. 2, the battery pack 11 mainly includes battery modules, a battery case 21 for containing the battery modules, and electronic equipment such as a battery control unit (BCU) for controlling the battery modules and a junction box. FIG. 2 omits illustrations of the battery modules, the BCU, the junction box, and so on, which are contained in the battery case 21.

The cooling structure 10 of the battery pack 11 mainly includes a battery pack 11, an intake duct 22 for sending cooling air, a blower 23 for pressure-feeding cooling air to the intake duct 22, a blower box 24 that fixes the blower 23 to the intake duct 22, and a dust filter 25.

As illustrated in the drawing, the intake duct 22 is coupled to a top surface 21A of the battery case 21 and communicates with the battery case 21. On the other hand, the blower box 24 that contains the blower 23 is disposed upstream of the intake duct 22. The dust filter 25 is disposed at an air inlet of the blower box 24. The blower 23 may be disposed in the intake duct 22 without using the blower box 24. In this case, the dust filter 25 is disposed at an upstream end of the intake duct 22.

As shown by arrows 26, the blower 23 is, for example, an axial blower, and it pressure-feeds air in a vehicle cabin to the intake duct 22. The intake duct 22 is coupled to, for example, a chamber (not illustrated) for cooling the battery modules, in the battery case 21. Air that flows in the intake duct 22 is supplied to the insides of the battery modules via the chamber. This air is, for example, air that is cooled by air conditioning equipment in the vehicle cabin and outside air, and it is used as cooling air for the battery modules.

The dust filter 25 is a member for collecting foreign matters such as dust, which are contained in the air in the vehicle cabin, and the like. Due to disposing the dust filter 25 at the air inlet of the blower box 24, after a certain amount of foreign matters contained in the air are removed, the air is pressure-fed into the intake duct 22 to be used as cooling air.

As shown by a square mark 27, the intake duct 22 is formed with a bent section 28. The bent section 28 of the embodiment is a bent area that is formed in a middle part of the intake duct 22 and that allows cooling air, which is sent from an upper side to a lower side of the vehicle 12, to be sent again from the lower side to the upper side of the vehicle 12. The intake duct 22 has an approximately U shape or an approximately V shape in a side view, at the bent section 28.

For example, the bent section 28 is formed lower than the top surface 21A of the battery case 21. In this structure, the bent section 28 is formed around the periphery of a side surface of the battery case 21, whereby the intake duct 22 is efficiently disposed relative to the battery case 21. This prevents the cooling structure 10 of the battery pack 11 from increasing in size and makes it easy to obtain the housing space 13 in the vehicle 12.

As illustrated in FIG. 3A, the bent section 28 of the intake duct 22 mainly has two bent parts 28A and 28B and a horizontal part 28C between the bent parts 28A and 28B. As shown by the arrows 26, cooling air that is sent from the upper side to the lower side collides with an inner surface of the intake duct 22 at the bent part 28A and is changed in the sent direction to an approximately horizontal direction, and it then flows to a downstream side in the horizontal part 28C of the intake duct 22. Subsequently, the cooling air collides with an inner surface of the intake duct 22 at the bent part 28B and is changed in the sent direction to a direction from the lower side to the upper side, and it then flows to the downstream side of the intake duct 22.

As illustrated in the drawing, a vibration absorber 32 is disposed at least at a collision area 33 to be collided with cooling air, which is represented by a bold solid line, at the bent part 28A of the intake duct 22. The vibration absorber 32 is a member for absorbing vibrations of cooling air to reduce noises such as rotation noise and wind noise of the blower 23, which are transmitted by cooling air. The vibration absorber 32 uses a porous flexible material, such as non-woven fabric or sponge.

As shown by arrows 31, cooling air that flows in the intake duct 22 collides with the vibration absorber 32, which covers the inner surface of the intake duct 22, at the bent part 28A, and it is changed in the sent direction from an approximately vertical direction to an approximately horizontal direction, along the shape of the intake duct 22. As described above, the vibration absorber 32 is disposed so as to cover at least the collision area 33 to be collided with cooling air, which is represented by the bold solid line.

With this structure, cooling air partially passes through the inside of the vibration absorber 32 and flows to the downstream side along the horizontal part 28C. Some cooling air is scattered in many directions by the surface of the vibration absorber 32 and then flows to the downstream side along the horizontal part 28C.

Cooling air is pressure-fed to the inside of the intake duct 22 by the blower 23. At this time, cooling air passes through the dust filter 25. Thus, cooling air is vibrated due to rotation of blades of the blower 23, passing through the dust filter 25, and other causes, and it thereby has various noise components.

As described above, cooling air passes through the inside of the vibration absorber 32 at the bent part 28A, whereby these vibrations of the cooling air are absorbed by the vibration absorber 32. This reduces noise components of the cooling air that flows in the intake duct 22.

As a result, these noises are reduced in a step before cooling air is sent to the inside of the battery case 21, and they are prevented from resonating in the battery case 21. Then, these noises are hardly transmitted to the inside of the vehicle cabin, whereby occupants in the vehicle 12 can easily have conversations and can easily listen to music, etc., resulting in improving comfort in the vehicle cabin.

Moreover, as illustrated in the drawing, the vibration absorber 32 is disposed so as to occupy a part of the intake duct 22, instead of blocking the whole passage cross section. In the embodiment, the vibration absorber 32 is disposed so that a space is left from a center part to an upper part of the passage cross section of the intake duct 22. On the other hand, the vibration absorber 32 is disposed from the center part to a lower part of the passage cross section of the intake duct 22, in an area from the bent part 28A to the middle part of the horizontal part 28C on the downstream side.

As described above, cooling air collides with the vibration absorber 32 and the inner surface of the intake duct 22 at the bent part 28A. This stagnates the flow of air and increases passage resistance of cooling air. In addition, the passage resistance of cooling air is increased also due to cooling air flowing inside the vibration absorber 32.

In view of this, in the cooling structure 10 of the battery pack 11 of the embodiment, the vibration absorber 32 partially blocks the passage cross section of the intake duct 22. This prevents the passage resistance from increasing excessively. On the other hand, the vibration absorber 32 extends long along the intake duct 22. This increases the amount of cooling air flowing inside the vibration absorber 32 and thereby increases the amount of absorbing vibrations. As a result, the blower 23 is prevented from being increased in size, and the cooling structure 10 of the battery pack 11 can be decreased in size as a whole. Moreover, the housing space 13 of the cooling structure 10 of the battery pack 11 in the vehicle 12 is easily obtained.

As illustrated in FIG. 3B, cooling air collides with the vibration absorber 32 and the inner surface of the intake duct 22 at the bent part 28A of the intake duct 22, and some cooling air passes through the inside of the vibration absorber 32. As described above, the vibration absorber 32 is a porous member such as of non-woven fabric, and it is used also as a filter for removing foreign matters 34. With this structure, when cooling air passes through the intake duct 22, foreign matters 34 are removed by the vibration absorber 32. As illustrated in the drawing, foreign matters 34 that are removed from cooling air are captured by holes of the vibration absorber 32 and are held on the surface and so on of the vibration absorber 32.

As shown by a circle 35, the bent part 28B of the intake duct 22 is positioned downstream of the bent section 28. Cooling air that flows in the intake duct 22 is changed in the sent direction from the approximately horizontal direction to the approximately vertical direction at the bent part 28B. In other words, cooling air is changed in the sent direction to a direction from the lower side to the upper side.

As described with reference to FIG. 3A, solid foreign matters 34 such as dust, in cooling air, are easily removed by the vibration absorber 32, but water vapor contained in cooling air is repelled at the surface of the vibration absorber 32 and is hardly removed. Water is a substance having a specific gravity greater than that of cooling air.

As shown by the arrows 26, cooling air is sent to the upper side along the intake duct 22. On the other hand, as shown by an arrow 36, water vapor that is contained in cooling air tends to fall to the bent part 28B due to the difference in specific gravity. For example, the intake duct 22 extends in the approximately vertical direction along the side surface of the battery case 21, whereby water vapor easily falls.

With this structure, dry cooling air from which the water vapor is removed, is sent to the battery modules in the battery case 21, whereby malfunctions caused by a short circuit, rusting on an electrode surface, and so on, can be prevented.

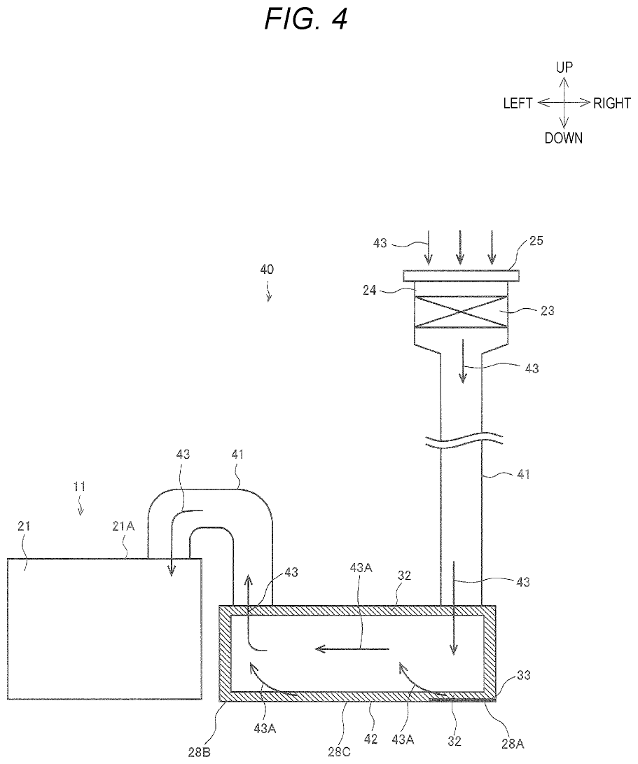

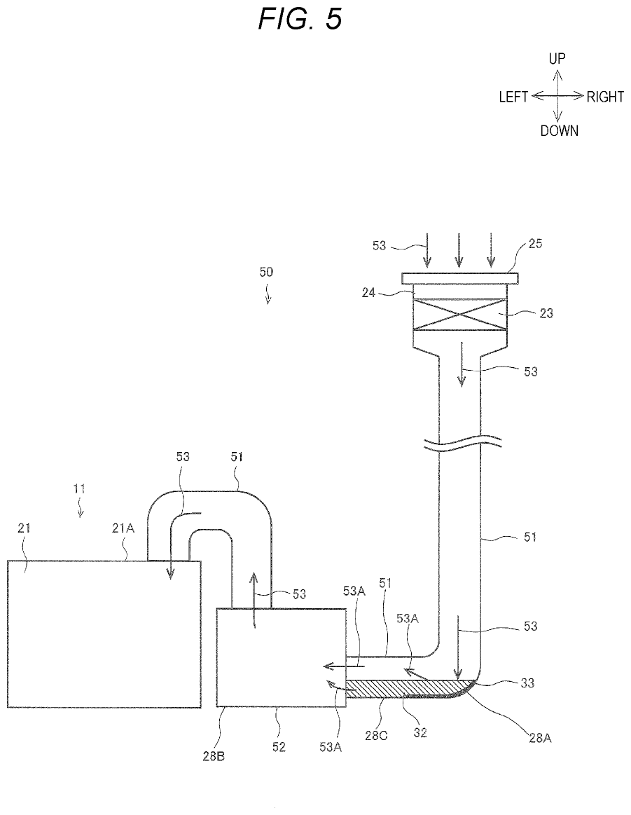

Next, cooling structures 40 and 50 of the battery pack 11 according to other embodiments of the disclosure will be described in detail based on FIGS. 4 and 5. It is noted that the embodiment is basically described by using the same reference numerals for the members that are the same as those in the cooling structure 10 of the battery pack 11, which are described with reference to FIGS. 1 to 3B, and repeated description is omitted. The front-rear direction illustrated on the paper represents a longitudinal width direction of the battery pack 11, the right-left direction illustrated on the paper represents a lateral width direction of the battery pack 11, and the up-down direction illustrated on the paper represents a height direction of the battery pack 11.

FIG. 4 is a schematic view of the cooling structure 40 of the battery pack 11 of the embodiment, in which a chamber 42 is disposed in a middle part of an intake duct 41.

As illustrated in FIG. 4, in the cooling structure 40 of the battery pack 11, the chamber 42 is coupled to the middle part of the intake duct 41. The cooling structure 40 of the embodiment differs from the cooling structure 10 in that the bent section 28 (refer to FIG. 2) of the cooling structure 10 is exchanged for the chamber 42.

The cooling structure 40 of the battery pack 11 mainly includes a battery pack 11, an intake duct 41 for sending cooling air, a blower 23 for pressure-feeding cooling air to the intake duct 41, a blower box 24 that fixes the blower 23 to the intake duct 41, and a dust filter 25.

The chamber 42 is disposed in the middle part of the intake duct 41 and is used as an air passage of cooling air. The intake duct 41 that extends from an upper side to a lower side is coupled to an upstream side of the chamber 42. On the other hand, the intake duct 41 that extends from the lower side to the upper side is coupled to a downstream side of the chamber 42.

The chamber 42 is, for example, a cuboid shape, and it has a passage cross section area greater than that of the intake duct 41. The chamber 42 is formed of the same resin material as the intake duct 41 and is permanently affixed to the intake duct 41 into one body. The chamber 42 may be formed as a separate body from the intake duct 41 and may be attached to the intake duct 41. In addition, the chamber 42 may be formed of a metal material as a separate body from the intake duct 41.

As shown by arrows 43, cooling air is pressure-fed to the intake duct 41 via the blower 23. The cooling air is then sent to the battery case 21 via the intake duct 41 and the chamber 42. The cooling air is supplied to the insides of the battery modules via a chamber (not illustrated) for cooling the battery modules, in the battery case 21.

As illustrated in the drawing, a vibration absorber 32 covers approximately the entire inner surface of the chamber 42. As shown by arrows 43A, cooling air that is sent to the inside of the chamber 42, collides with the vibration absorber 32 and a bottom surface of the chamber 42, at a bent part 28A in the chamber 42, and it is changed in the sent direction from an approximately up-down direction to an approximately right-left direction.

With this structure, as shown by the arrows 43A, cooling air partially passes through the inside of the vibration absorber 32 and flows to the downstream side of the chamber 42. Some cooling air is scattered in many directions by the surface of the vibration absorber 32 and then flows to the downstream side of the chamber 42. As a result, the above-described vibrations of cooling air are absorbed by the vibration absorber 32, whereby a noise reduction effect is obtained in the same manner as in the cooling structure 10. The effect for removing foreign matters contained in cooling air by the vibration absorber 32 is also obtained in the same manner as in the cooling structure 10.

Moreover, in the cooling structure 40 of the battery pack 11, cooling air that flows inside the chamber 42 is reduced in pulsation and is straightened. This results in reduction in vibration of the intake duct 41 and in vibration of the vehicle 12, whereby comfort of occupants in the vehicle 12 is improved.

FIG. 5 is a schematic view of the cooling structure 50 of the battery pack 11 of the embodiment, in which a chamber 52 is disposed in a middle part of an intake duct 51.

As illustrated in FIG. 5, in the cooling structure 50 of the battery pack 11, the chamber 52 is coupled to the middle part of the intake duct 51. The cooling structure 50 of the embodiment differs from the cooling structure 10 in that the chamber 52 is disposed downstream of the bent part 28A (refer to FIG. 2) of the cooling structure 10.

The cooling structure 50 of the battery pack 11 mainly includes a battery pack 11, an intake duct 51 for sending cooling air, a blower 23 for pressure-feeding cooling air to the intake duct 51, a blower box 24 that fixes the blower 23 to the intake duct 51, and a dust filter 25.

The chamber 52 is disposed in the middle part of the intake duct 51 and is used as an air passage of cooling air. The intake duct 51 that extends in an approximately horizontal direction (right-left direction illustrated on the paper) is coupled to an upstream side of the chamber 52. On the other hand, the intake duct 51 that extends in an approximately vertical direction (up-down direction illustrated on the paper) is coupled to a downstream side of the chamber 52. The shape and the material of the chamber 52 are the same as or similar to those of the chamber 42 of the cooling structure 40.

As shown by arrows 53, cooling air is pressure-fed to the intake duct 51 via the blower 23. The cooling air is then sent to the battery case 21 via the intake duct 51 and the chamber 52. The cooling air is supplied to the insides of the battery modules via a chamber (not illustrated) for cooling the battery modules, in the battery case 21.

The cooling structure 50 of the battery pack 11 provides effects as in the case of the cooling structure 10. That is, a vibration absorber 32 that is disposed at a bent part 28A absorbs the above-described vibrations of cooling air to reduce noises and removes foreign matters contained in cooling air. Moreover, cooling air that flows inside the chamber 52 is reduced in pulsation and is straightened.

Although a case of disposing the vibration absorber 32 so as to cover the collision area 33 of the intake duct 22 is placed in the embodiment, the placement position is not limited thereto. In one example, the vibration absorber 32 may be placed circularly on the inner surface, including the collision area 33, of the intake duct 22. Various other modifications and alterations can be made without departing from the gist of the disclosure.

In the cooling structure of the battery pack of the embodiment of the disclosure, the intake duct for sending cooling air to the battery case is formed with the bent section in which cooling air that is sent from the upper side to the lower side is sent again from the lower side to the upper side. In addition, the vibration absorber is disposed in the collision area to be collided with cooling air, of the bent section. With this structure, at least some cooling air passes through the inside of the vibration absorber, whereby vibrations of the cooling air are absorbed, and noises are reduced.

1. A cooling structure of a battery pack, the cooling structure comprising:
a battery case containing a battery module;
an intake duct communicating with the battery case and being configured to send cooling air for cooling the battery module; and
a blower being configured to supply the cooling air to the intake duct,
the intake duct having a bent section in which the cooling air that is sent from an upper side to a lower side is sent again from the lower side to the upper side, wherein
in the bent section of the intake duct, a vibration absorber is provided at least at a collision area to be collided with the cooling air.

2. The cooling structure of the battery pack according to claim 1, wherein
the bent section is provided at a position lower than an upper surface of the battery case, and
the intake duct is coupled to the battery case at a position higher than the bent section.

3. The cooling structure of the battery pack according to claim 1, wherein
a chamber that allows the cooling air to pass therethrough is provided in a middle part of the intake duct, and
the bent section is provided in the chamber.

4. The cooling structure of the battery pack according to claim 1, wherein the vibration absorber is made of non-woven fabric.

5. The cooling structure of the battery pack according to claim 2, wherein the vibration absorber is made of non-woven fabric.

6. The cooling structure of the battery pack according to claim 3, wherein the vibration absorber is made of non-woven fabric.

7. The cooling structure of the battery pack according to claim 8, wherein the vibration absorber is made of non-woven fabric.
